(19) United States
(12) Patent Application Publication
(10) Pub. No.: US 2023/0066759 A1
(43) Pub. Date: Mar. 2, 2023

(54) PROXY MODEL WITH DELAYED RE-VALIDATION

(71) Applicant: Cisco Technology, Inc., San Jose, CA (US)

(72) Inventors: Nassim Benoussaid, Jette (BE); David John Zacks, Vancouver (CA); Zizhen Gao, San Ramon, CA (US); Carlos M. Pignataro, Cary, NC (US); Dmitry Goloubev, Waterloo (BE)

(21) Appl. No.: 17/463,738

(22) Filed: Sep. 1, 2021

(51) Int. Cl. G06N 20/00

(52) U.S. Cl. CPC G06N 20/00

(57) ABSTRACT

Techniques are provided for segmentation of data points after a dimension reduction. A proxy model is then trained based on results of the segmentation. The proxy model provides low latency high throughput labeling of additional data points, without the need to reduce dimensions of the additional data points. A second segmentation is performed with results of the second segmentation compared to that of the first segmentation. When results of the comparison meet certain criterion, configuration parameters of the segmentation are modified. For example, in some embodiments, a user interface is provided that displays shapley values indicating a mapping from the high dimension data to the segmented data. Input is then received that modifies the configuration parameters.

### TECHNICAL FIELD

The present disclosure relates to management of dataset labeling processes.

### BACKGROUND

One approach to labeling a dataset is to segment the dataset into a plurality of clusters. A subject matter expert (SME) then assigns labels to each cluster. However, a subject matter expert (SME) has a finite ability to label these clusters and any new data points. In practical terms, this limits an amount of input an SME can provide.

### BRIEF DESCRIPTION OF THE FIGURES

FIG. 1 is an overview diagram showing a data segmentation process in accordance with an example embodiment.

FIGS. 2A and 2B show an example of data evolution over time, in accordance with an example embodiment.

FIGS. 3A and 3B show another example of drift in accordance with an example embodiment.

FIG. 4A is a dataflow diagram of a data segmentation process.

FIG. 4B illustrates a segmentation system implementing one or more of the disclosed embodiments.

FIG. 5 is a data flow diagram illustrating operation of a drift detection method in accordance with an example embodiment.

FIG. 6 is a flowchart of a method of determining when to re-label a set of data points via an SME.

FIG. 7 is a hardware block diagram of a device 700 that may perform functions associated with operations discussed herein in connection with the techniques depicted in any one or more of FIGS. 1-6.

### DESCRIPTION OF EXAMPLE EMBODIMENTS

### Overview

The disclosed embodiments segment data points, into a first segmentation, and train a proxy model based on this first segmentation. The proxy model provides low latency high throughput labeling of additional data points. Results of a subsequent segmentation are compared to the first segmentation, and when particular criterion are met, configuration parameters of the segmentation process are adjusted. Thus, in one form, a method is provided that comprises generating, based on segmentation parameters and a first set of data points, a first segmentation, wherein the first segmentation associates a segment with each data point in the first set of data points, training a proxy model based on the first segmentation, labeling, based on the proxy model, a second set of data points, outputting the labeled second set of data points, generating, based on the segmentation parameters, the first set of data points and the second set of data points, a second segmentation, wherein the second segmentation associates a segment with each data point in the first set of data points and the second set of data points, comparing the first segmentation and the second segmentation, triggering an adjustment of the segmentation parameters based on the comparing, generating, based on the adjusted segmentation parameters, the first set of data points, a second set of data points, a third set of data points, and a third segmentation; and outputting a labeled fourth set of data points based on the third segmentation.

In some embodiments, comparing the first segmentation and the second segmentation includes determining whether each segment of the first segmentation has associated data points in the second segmentation; and modifying the first segmentation parameters in response to at least one segment of the first segmentation lacking associated data points in the second segmentation. In some embodiments, comparing the first segmentation and the second segmentation includes determining whether any segment of the second segmentation is associated with data points associated with two or more segments of the first segmentation, and modifying the first segmentation parameters in response to a segment of the second segmentation being associated with data points associated with two or more segments of the first segmentation.

In some embodiments, the method further includes comparing the labeled second set of data points to the second segmentation, and training the proxy model on the second segmentation in response to the comparing. In some embodiments, the method further includes determining a maximum distance between each data point of the first set of data points and the second set of data points, and a centroid of a segment associated with the data point, and modifying the first segmentation parameters based on the determination.

In some embodiments, modifying the first segmentation parameters includes modifying one or more of a distance function, density threshold, a number of expected clusters, a hyper-parameter, or a label definition of particular segments or clusters. In some embodiments, the first segmentation includes reducing dimensions of the first set of data points to generate a reduced dimension set of data points, and segmenting, based on the reduced dimension set of data points.

In some embodiments, the method includes presenting, on a user interface, a shapley value based on the second segmentation, and receiving input indicating a modified segmentation parameter from the user interface, wherein the third segmentation is based on the modified segmentation parameter. In some embodiments, the presenting is in response to the triggering.

In some embodiments, the first set of data points represent operational parameter values of a computer network, and the outputting includes outputting labeled data to a network diagnostic application, or the first set of data points represent electronic document data, and the outputting also includes outputting labeled data to a data filtering application.

### Example Embodiments

A problem arises when the SME focused approach described above is used in a production environment. For example, as time elapses, processes underlying the data generation evolve (e.g., network devices age, can be reconfigured to carry different traffic, operate in a different environment, or experience other changes). This evolution causes the data being generated to also evolve, and characteristics of new data can begin to deviate from that of previously observed data. This evolution of the data causes an existing data segmentation to become less accurate over time, to a point when a new segmentation should be performed that takes into account both the older data, and the newer data with the evolved characteristics. Some of the new data may need to be labeled via the assistance of a SME. For example, while some percentage of the new data may be clearly associated with previously defined groups of data (e.g., clusters), appropriate segments or clusters for at least a portion of the new data may require SME assistance to designate the appropriate cluster, or perhaps even a new cluster. For example, the dataset when the new data is considered may form eleven groups whereas the previous dataset formed ten groups.

The disclosed embodiments propose a method of extrapolating existing data labels (provided by an SME) in order to detect a stage when new data deviates far enough away from a ground truth that it can no longer be usefully applied. When this occurs, additional input from the SME is solicited. This problem is applicable to most systems involving operational data from network devices and using models build with supervised machine learning e.g., hardware failure prediction).

Many existing methods focus on collecting expert knowledge for bootstrapping the 1st model. For example, https://prodi.gy/, https://trainingset.ai, or https://snorkel.ai/. Most of these systems combine a form of active learning (with negative sampling or other approaches) and workflow management. However once the model is in production, detection of the moment when a model drifts away from ‘reality’ is still done ad hoc. Additionally an effort to update the annotated data (ground truth) remains practically the same as the first time the data was segmented. This imposes an ‘expert attention’ bottleneck upon many predictive systems, such that the SME attention requirements of the system are too expensive to maintain while also ensuring a sufficiently high level of accuracy.

Some existing systems focus on providing the SME with tools to collect ground truth information for the data. These existing systems are not examining the task of monitoring the expert input applicability to a current generation of data. Evolution of data over time is a common problem, such that fresh data drifts away from a previous segmentation. The disclosed embodiments provide a system and method for reducing an amount of input needed from the SME by detecting when existing ground truth is insufficient to accurately classify new data (and thus prompt for new expert involvement).

The disclosed embodiments track when system non-stationarity will render existing SME annotations inapplicable. Such situations trigger new data/model review by the SME. Additionally, the disclosed embodiments apply annotations made by SMEs to new data via inference. These embodiments project data (with SME involvement) to a low-dimensional representation that allows spatial annotation. A role of the SME is to ensure that congregations of data points maintain domain relevance (i.e., similar points are close, and different points from a domain-specific point of view are at distance).

Thus, the disclosed embodiments operate in conjunction with an SME assisted machine learning anomaly detection tool, and improve the robustness of this classical prediction tool with respect to time changes, while minimizing expert involvement (e.g., resulting in an operating expense (OPEX) reduction).

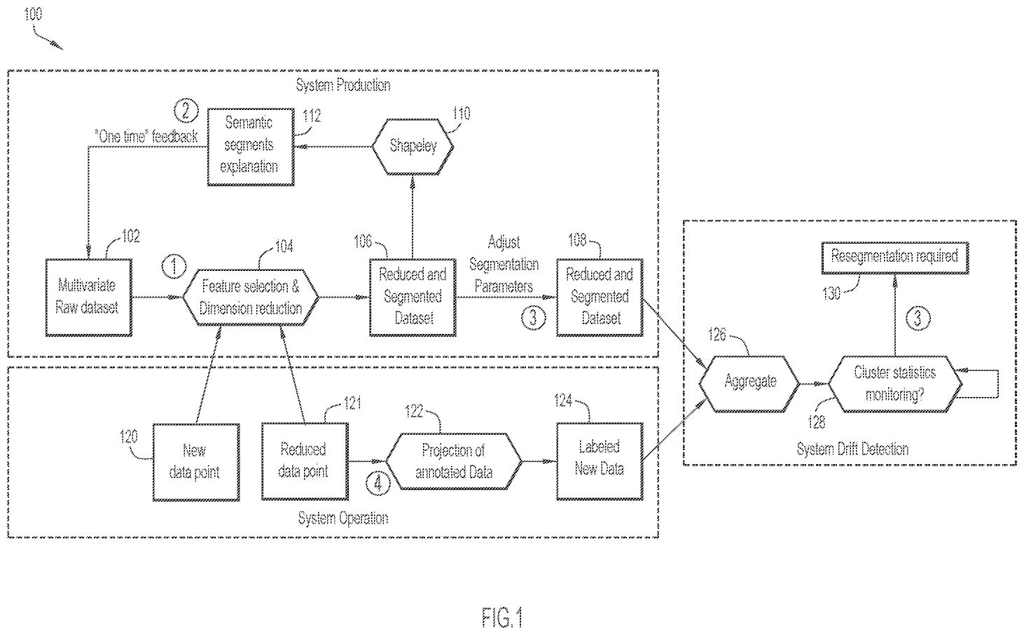

FIG. 1 is an overview diagram showing a data segmentation process in accordance with an example embodiment. The data segmentation process 100 of FIG. 1 includes several steps, including data preparation and unsupervised segmentation, segment visualization, segment annotation, annotation projection to new data, system drift detection, and loop back to re-segment the data. The data preparation and unsupervised segmentation step begins with high dimension, multi-variant raw dataset 102. Meaningful features are selected in operation 104 (i.e., feature selection and dimension reduction). The selection is performed manually or using other methods (e.g., via a recursive feature selection method, feature importance, statistical methods, or other approaches). In some embodiments, dimensions of the high dimension, multi-variant raw dataset 102 are reduced, and then the reduced dimension data set is segmented, resulting in a reduced and segmented dataset 106. Dimensions of the high dimension, multi-variant raw dataset 102 are reduced when too many features are left to interpret (e.g., via a high correlation filter, principal component analysis, or other methods). In some embodiments, the reduced dimensions dataset is segmented again by adjustment of segmentation parameters. The segmenting uses, in at least some embodiments, unsupervised clustering methods. This results in a second segmented dataset 108. The second segmented dataset 108 includes labels automatically assigned by the clustering method to each data point of the high dimension, multi-variant raw dataset 102.

Unsupervised segmentation methods result in data that can be hard to interpret, especially after a dimension reduction step. SMEs are used, in some embodiments, to provide feedback on whether a segmentation has semantic relevance to a problem domain. As a result, features relied upon to perform the initial unsupervised segmentation are, in some cases, revised, and the unsupervised segmentation performed again based on the adjusted feature set. In some environments, an unsupervised segmentation is performed for each problem domain and/or data match. For example, when predicting hardware failures from given sensor data, segmentation is performed once, in at least some circumstances. If new sensors are brought online, these new sensors will likely contribute additional information not considered in the initial segmentation. Thus, the segmentation is, at least in some circumstances, performed again.

One of the nuances of solving this problem is to provide the SME with a means to understand high-dimensional data after it has been through the transformations included in the segmentation. Some of the disclosed embodiments employ Shapley values 110 to provide an explanation 112 of a presence of a particular data point in a particular segment. Thus, some of the disclosed embodiments facilitate visualization of high dimension data with its assigned segment in low dimensional space via AI bias decomposition approaches (such as Shapley). In some embodiments, this visualization is provided via a user interface. This allows an SME to read Shapley output for each data point. In various embodiments, the visualization is performed graphically, while other embodiments utilize a table format.

Once the semantic relevance of segmentation is confirmed, the segments are annotated according to the segmentation. This may vary based on the nature of a process utilizing the annotation/labels (e.g., classification, anomaly detection, etc.). In some circumstances, segments have a ‘default’ annotation and thus most segments can be annotated without human involvement. In some circumstances, one or more outlier segments are annotated manually. For example, in an application that predicts hardware failures, an SME is relied upon, in some circumstances, to annotate segments that represent ‘benign outliers’ as both ‘normal’ and ‘marginal’ segments. The ‘benign outliers’ are detected automatically (e.g. without human intervention), in at least some embodiments, to provide for easier SME annotation.

As new data 120 is obtained, dimensions of the new data are reduced to generate a reduced data point 121. Re-segmentation is performed so as to apply the annotations, via projection 122 of the segmentation to the new data. This results in labels being assigned to the new data 120 as labeled new data 124. Generally, most new data will be associated with one of the predefined segments by the re-segmentation. This allows the new data to benefit from the prior segmentation and annotation, without requiring manual involvement in determining annotations/labels for the new data.

FIG. 1 shows that segmentation of data provided by the second segmented dataset 108 and the labeled new data 124 are aggregated in aggregation operation 126. Statistics relating to segmentation of this group of data are monitored at decision operation 128. When certain conditions are met, a decision to re-segment the data is made in operation 130. Note that in the data segmentation process described above, before new data is labeled, the dimensions of the data are reduced to be consistent with that of the reduced and segmented dataset 106.

Machine learning (ML) models are also commonly applied to classification problems. However, over time, if a character of data being classified by the ML model migrates away from the data used to train the ML model, the ML model's accuracy and precision will suffer. Effects of such a migration can be visualized as a drift over time, as a movement of a centroid of a segment or cluster of the data with respect to an aggregation of the training data and the new data classified by the model.

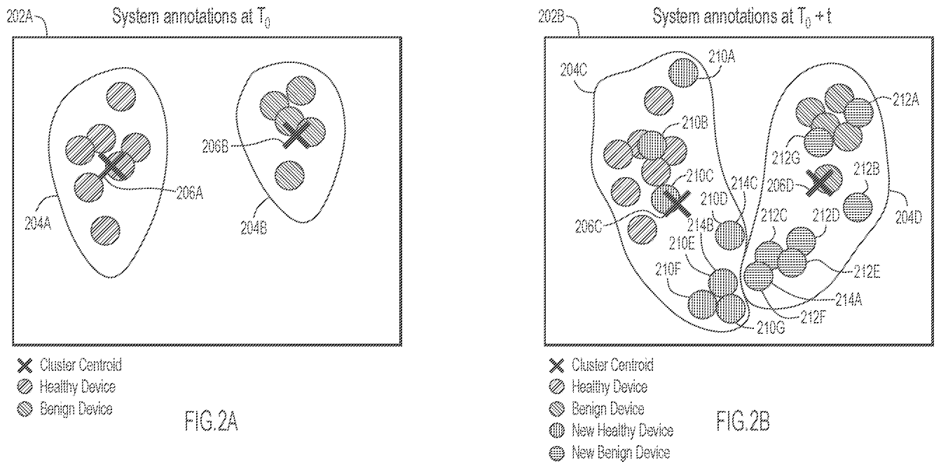

When a drift in the character of the data becomes large enough, the existing annotations can no longer be effectively applied (with adequate precision) to some percentage of the new data being classified. An example of such a drift is provided below with respect to FIGS. 2A and 2B.

FIGS. 2A and 2B show an example of data evolution over time, in accordance with an example embodiment. Two data plots are shown, a first data plot 202A and a second data plot 202B. The first data plot 202A shows data points available for segmentation at a first time t. Two distinct segments or clusters of data are shown as a first segment or cluster 204A and a second segment or cluster 204B. Each of the data points are unambiguously associated with either the first segment or cluster 204A (e.g., indicating a healthy device) or the second segment or cluster 204B (e.g., indicating a “benign” device), based at least in part, on relatively large differences in distances between each data point and the two clusters. Thus, if a distance to a first centroid 206A of the first segment or cluster 204A is substantially different from a second distance to a second centroid 206B of the second segment or cluster, there is little ambiguity as to which cluster the data point is properly associated.

In contrast, the second data plot 202B illustrates what occurs when a character of data changes over a period of time. The second data plot 202B illustrates that a third cluster or segment 204C having a third centroid 206C exists based on the addition of new data, identified as new data 210A, new data 210B, new data 210C, new data 210D, new data 210E, new data 210F, and new data 210G. The third centroid 206C represents a drift of the first centroid 206A in the first data plot 202A based on the new data 210A-G. A fourth segment or cluster 204D having a fourth centroid 206D also now exists based on the addition of new data, identified as new data 212A, new data 212B, new data 212C, new data 212D, new data 212E, new data 212F, and new data 212G. The fourth centroid 206D represents a drift of the second centroid 206B based on the new data 212A-G. Note that the second data plot 202B includes several data points that have some level of ambiguity associated with which cluster they are best assigned. For example, the data point 214A data point 214B, and data point 214C (e.g., associated with “marginal” region of a segment) have a higher level of ambiguity relative to, for example, the data points of the first data plot 202A.

The disclosed embodiments provide for segmentation or clustering of a set of data points. Clustering and segmenting are used synonymously throughout this disclosure. A cluster or segment of data points is an association between a plurality of data points that are assigned or associated with a cluster or segment. A segmenting process defines, based on data points that are provided as input, a plurality of segments. In some embodiments, each segment is defined, at least in part, by a centroid of the segment. The centroid represents a location within a vector space having a minimum cumulative distance from locations (also within the vector space) of all data points assigned to or associated with the segment. Some embodiments provide a one to one mapping between a label and a segment or cluster of a segmentation. Thus, for example, a group of data points assigned to or associated with a particular cluster are labeled with a label unique to that cluster or group of data points. Each cluster within a segmentation has, in some embodiments, a label unique to the segmentation (e.g., no other cluster has the same label). This relationship between segments, clusters, labels, and centroids will be applied in the discussion below.

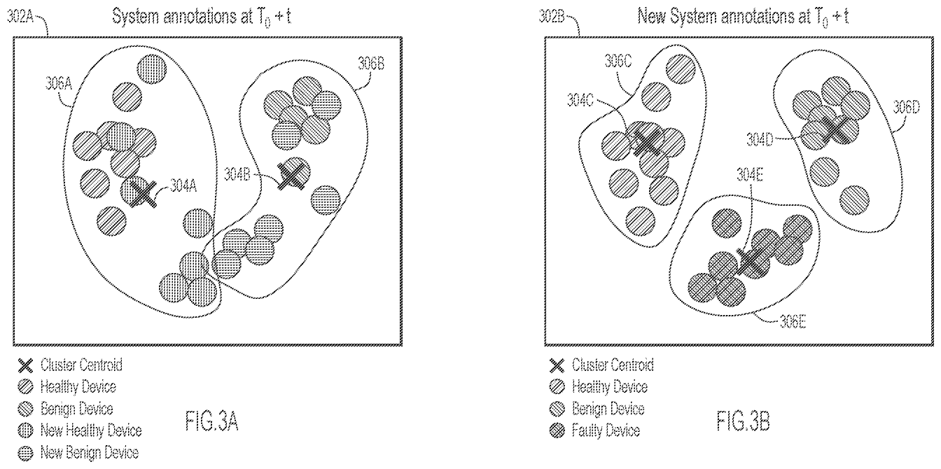

FIGS. 3A and 3B show another example of drift in accordance with an example embodiment. FIGS. 3A and 3B show two data plots, a third data plot 302A, and a fourth data plot 302B respectively. The third data plot 302A is analogous to the second data plot 202B of FIG. 2B. Thus, the third data plot 302A shows two cluster centroids, a first centroid 304A and a second centroid 304B of a first segment or cluster 306A and second segment or cluster 306B respectively. The fourth data plot 302B represents a re-segmentation of the data points of the third data plot 302A. The re-segmentation has changed a location of centroids of the first segment or cluster 306A and the second segment or cluster 306B. The location of the centroids in the fourth data plot 302B are shown a third centroid 304C and a fourth centroid 304D for a third segment or cluster 306C and fourth segment or cluster 306D. The third segment or cluster 306C is analogous to the first segment or cluster 306A of the third data plot 302A. The fourth segment or cluster 306D is analogous to the second segment or cluster 306B. Thus, in some embodiments, a label assigned to data points within the fourth segment or cluster 306D is equivalent to a label assigned to data points previously within the first segment or cluster 306A.

The fourth data plot 302B also shows identification of an additional segment or cluster 306E, having a centroid 304E. Thus, a re-segmentation, as represented by the fourth data plot 302B, results, in some circumstances, in data points previously associated with a first segment or cluster (e.g., the segment or cluster 306A being associated with a different segment or cluster (e.g., the segment or cluster 306E).

One approach to addressing the drift problem illustrated in FIGS. 2A and 2B and FIGS. 3A and 3B is to re-segment the data with each new data point, and re-assess its validity. However, since a re-segmentation requires a projection of data to a low-dimensional space and a re-computation of a new point's representation (as discussed above with respect to FIG. 1), this solution is relatively slow and compute-intensive. To avoid the heavy computation burden imposed in the approach above with every point, the disclosed embodiments utilize a proxy model with delayed re-validation.

In some embodiments, a proxy model is combined with a distance-based approach (such as k-nearest neighbor (KNN)). With these embodiments, events that trigger modification of segmentation parameters include (1) an emergence of new unidentifiable segments or clusters during delayed re-validation (2) points in ambiguous locations (e.g., at a decision boundary or in a subspace where model prediction are brittle) or previously separate groups mix (as observable via silhouette analysis), or (3) data points at distances exceeding those previously observed within a segment or cluster. These conditions are mathematically detected, in at least some embodiments, via monitoring of metrics such as segment dispersion, centroid drift or distance between centroids.

In some embodiments, a triggering of a modification of segmentation parameters includes, review, by an SME of the criterion (1, 2, and 3) discussed above and re-validation of a new segmentation. The SME can also explore reasons a decision boundary changed using, for example, the tools discussed above.

The disclosed embodiments operate effectively with both independent and identically distributed (IID) data and time-series data. For example, an embodiment providing predictions of hardware failures, new data can include sensor readings data from previously unseen devices, as well as new data points for currently observed devices. The disclosed embodiments provide advantages via more efficient tuning of segmentation parameters, which may include more efficient use of SME time. This enables more scalable predictive services, as tuning of segmentation parameters commonly represents a relatively large bottleneck that hinders wider adoption of predictive systems and services. The disclosed embodiments provide significant improvements relative to “pure ML” systems as well as “pure expert” systems.

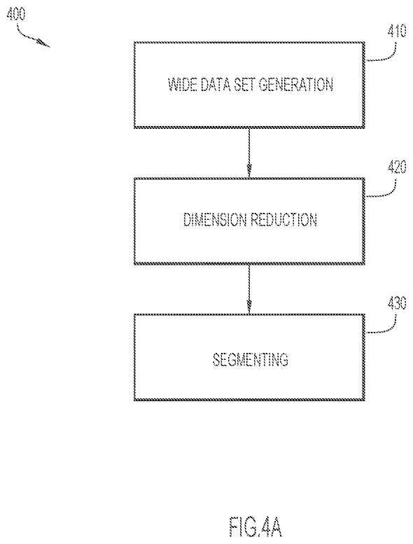

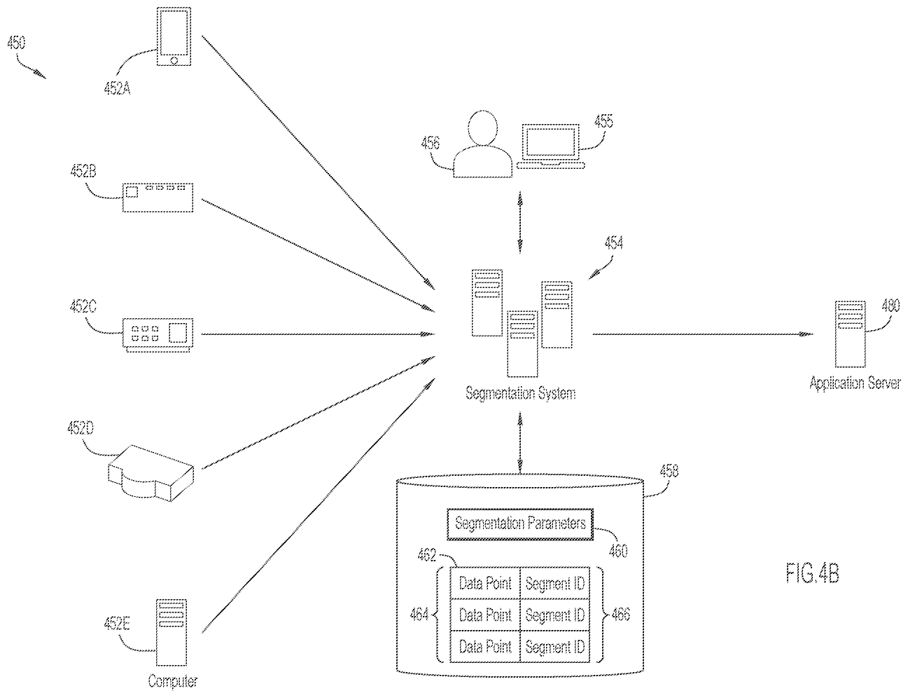

FIG. 4A is a flowchart of a data segmentation process. In the data flow of FIG. 4A, incorporation of new data points into the segmentation requires rebuilding of narrow data, and is thus computationally expensive.

FIG. 4A shows that a wide data set is generated in operation 410. A wide data set has a relatively large number of dimensions, which is a number of dimensions greater than that of data which is segmented. The wide data set of operation 410 includes, in some embodiments, a data set from which data that was previously processed and segmented by method 400 was derived, along with some new data that is being processed by method 400 for the first time.

The wide data sets dimensions are reduced in a dimension reduction operation 420. This results in a reduced dimension set of data points. The reduced dimension set of data points has a smaller number of dimensions than the wide data set of operation 410.

In some embodiments, the dimension reduction operation 420 utilizes t-distributed stochastic neighbor embedding (t-sne) and/or uniform manifold approximation and projection for dimension reduction (UMAP) to achieve the reduction in dimensions. A result of the dimension reduction operation 420 is narrow data. In some embodiments, method 400 already has available narrow dimension versions of data previously processed by method 400. For example, some embodiments store narrow dimension data in a data store such that it does not need to be put through a data dimension reduction process multiple times. Thus, to reduce data previously processed by method 400, method 400 reads, in some embodiments, a data store that stores the previously reduced data set. In these embodiments, the dimension reduction operation 420 performs data reduction on any data not previously processed by method 400. Other embodiments operate differently, for example, processing the entire wide data set of operation 410 to generate a reduced dimension data set.

Segmentation in operation 430 is based on the reduced dimension data set. In some embodiments, the segmentation or grouping of operation 430 utilizes density-based spatial clustering of applications with noise (DBSCAN), and/or ordering points to identify the clustering structure (OPTICS). A result of the segmentation is an association between each data point included in the segmentation and a particular segment or cluster. Some embodiments associate unique labels with each cluster, and therefore, each data point is labeled as a result of the segmentation.

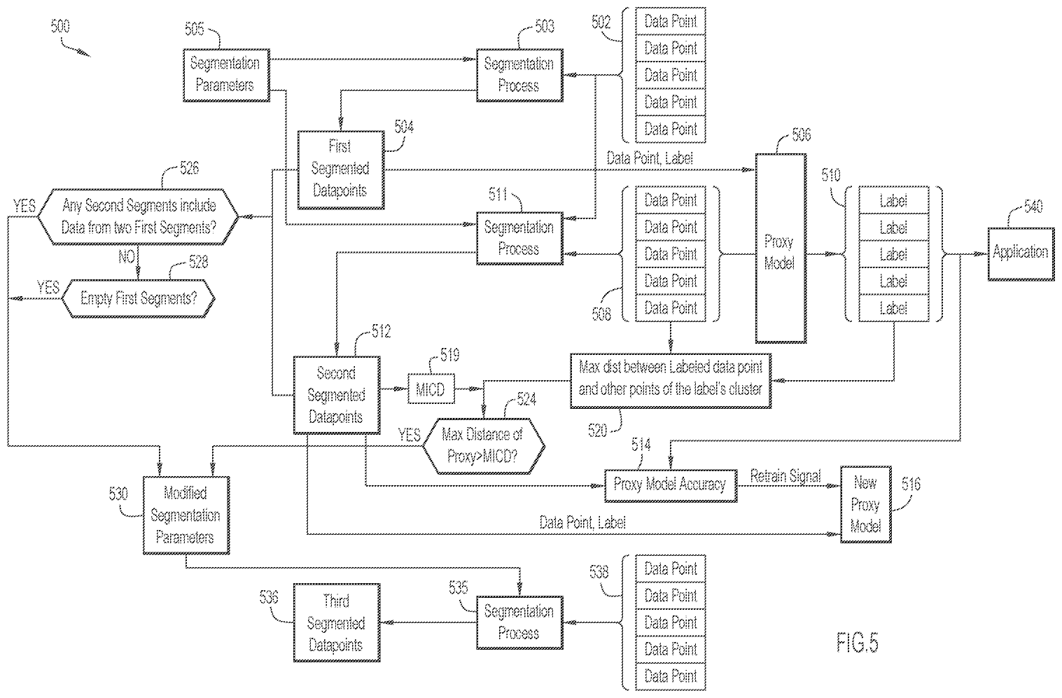

The computational intensity of the data flow of FIG. 4A demonstrates a need to enable inferences (e.g., labeling of data points) with low-latency and high speed. The disclosed embodiments solve this problem via a proxy model described in more detail with respect to FIG. 5 below. The proxy model is trained based on segmentation of a first set of high dimension data points. The proxy model then classifies or labels new wide dimension data. This eliminates the need to convert the high dimension data of operation 410 above into the lower dimensioned data resulting from the dimension reduction operation 420. Some of the disclosed embodiments then monitor accuracy and drift of the segmentation performed by method 400 via periodic drift detection (e.g. delayed re-validation).

FIG. 4B illustrates a data processing system 450 including a segmentation system implementing one or more of the disclosed embodiments. FIG. 4B shows a plurality of data generating devices, a phone 452A, a switch 452B, a router 452C, a router 452D, and a computer 452E. The plurality of data generating devices provide data, either directly or indirectly, to a segmentation system 454. For example, in some embodiments, the plurality of data generating devices transmit data over a network (not shown in FIG. 4B) to the segmentation system 454. In other embodiments, the plurality of data generating devices write the data, either directly or via one or more intermediate devices, to a data store (not shown in FIG. 4B) that it then read by the segmentation system 454.

The segmentation system 454 performs data segmentation as described in this disclosure. In some embodiments, the segmentation system segments a group of data points using a clustering or segmentation algorithm (e.g., such as KNN, affinity propagation, agglomerative clustering, balanced iterative reducing and clustering using hierarchies (BIRCH), DBSCAN, K-means, Mean shift, OPTICS, Spectral clustering, mixture of Gaussians, or other algorithms). The segmentation system 454 stores results of a segmentation in a data store 458. The segmentation system, in some embodiments, is configured to present one or more user interfaces, for example, on a parameter modification device 455. The parameter modification device 455 displays the one or more user interfaces and accepts input, e.g., provided by an SME 456, defining modifications to one or more segmentation parameters 460 that influence or otherwise control segmentations performed by the segmentation system. An example structure of a segmentation performed by the segmentation system 454 is shown as segmentation 462, which associates data points 464 (e.g., received from one or more of the plurality of data generating devices) with particular segments or clusters 466 defined by a segmentation.

In some embodiments, the segmentation system 454 also performs data labeling, for example, via a proxy model as discussed above. In some embodiments, the proxy model is also trained via the segmentation system 454. After data is labeled either by the proxy model, or in some embodiments, by a segmentation, the labeled data is provided to an application server 480. The application server 480 executes a variety of applications depending on an embodiment. An application running on the application server 480 consumes labeled data in order to perform additional analysis on the labeled data and generate further results or output. A list of potential applications that consume labeled data is too large to list, but includes, for example, hardware diagnostic applications, internet filtering applications, virus scanning applications, document management applications, data protection applications, and many others.

FIG. 5 is a data flow diagram 500 illustrating operation of a drift detection method in accordance with an example embodiment. In some embodiments, drift detection is performed periodically (for example once per week and/or in proportion to an arrival of new data (e.g., every predefined number of new data points). As new data arrives, the proxy model classifies or labels the data. A more complete data set (including, for example, data previously segmented and new data that has arrived since the last segmentation was performed), is also periodically, or when particular conditions are met, re-segmented.

Due to the non-linear nature of the reduction algorithms (e.g., t-sne, UMAP), a resulting shape of narrow data may appear very different from the original high-dimension data. This is alleviated via a cluster re-identification step that relies on labels assigned to clusters during a prior training, along with data points associated with those clusters during the training. Using the labels from the prior segmentation, segments resulting from the re-segmentation are associated, when possible, with the segments of the prior segmentation. Labels of the prior segmentation and then assigned to associated segments of the re-segmentation. In some circumstances, a segment resulting from the re-segmentation includes or encompasses some data points from multiple segments (e.g., two or more segments) of the prior segmentation. Alternatively, the re-segmentation results, in some circumstances, in a previous segment of the prior segmentation without any data points assigned in the newer segmentation. These conditions are used, in some embodiments, as a trigger for SME assistance with training of the segmentation model.

Some embodiments also verify accuracy of the proxy model by comparing labels generated by the proxy with labels indicated by the re-segmentation of a dataset that includes data labeled by the proxy model. If the determined accuracy meets a criterion (e.g., is below a predefined threshold), the proxy model is retrained, with the retraining including labels assigned by the re-segmentation.

Thus, to illustrate the above via FIG. 5, a first set of data points 502 is segmented into a first set of segmented data points 504. The first set of data points 502 represent high dimension data. In order to generate the first set of segmented data points 504, the first set of data points 502 is processed by a segmentation process 503 (analogous to the method 400 discussed above with respect to FIG. 4A). The segmentation process 503 includes dimension reduction of the first set of data points 502 before the first set of segmented data points 504 is generated (e.g., the first set of segmented data points 504 are based on the reduced dimension data). The segmentation performed by the segmentation process 503 relies, or is based on, a set of segmentation parameters 505. The type and value of segmentation parameters vary by embodiment, but include, in some embodiments, one or more of a normalization range, a distance function to use, a density threshold, or a number of expected clusters, label definitions of particular segments or clusters (provided by an SME in some embodiments), selection of features used for segmentation, group semantics, a hyper parameter (e.g., optimum epsilon distance (eps), or a minimum number of neighbors a given point should have in order to be classified as a core point (min samples)), distance function (Euclidian distance, Manhattan, etc.), feature selection (e.g., which sensor data from a plurality of available sensors are included in a segmentation), or other parameters).

The first set of segmented data points 504 associates each data point of the first set of data points 502 with a segment, cluster and/or label. In some embodiments, the label of a data point identifies a segment or cluster to which the data point has been associated via the segmentation process 503 (e.g., FIG. 4A) that generated the first set of segmented data points 504. The first set of segmented data points 504 is then used to train a proxy model 506. The training of the proxy model 506 establishes a correlation or relationship between the data points in the first set of data points 502 and the labels assigned to each data point via the first set of segmented data points 504.

FIG. 5 also shows a second set of data points 508. The second set of data points 508 is characterized as high dimension data, in that these data points include more dimensions than data used to perform the first segmentation that generated the first set of segmented data points 504. The second set of data points 508 is assigned a label by the proxy model 506. The assigned labels are shown as labels 510 of FIG. 5. The labels 510 are provided to an application 540 that consumes labeled data. The application 540 can be a variety of different types of applications depending on embodiment. As discussed above with respect to the application server 480, a type of the application 540 is, in some embodiments, one of a diagnostic application, document management application, network security application, or some other type of application that consumes labeled data.

An additional segmentation, or re-segmentation (e.g., via method 400 of FIG. 4A) is performed by segmentation process 511 that incorporates the first set of data points 502 as well as the second set of data points 508, to generate a second set of segmented data points 512. The segmentation process 511 includes performing a dimension reduction on the first set of data points 502 and the second set of data points 508 before segmenting the data points to produce the second set of segmented data points 512.

An accuracy 514 of the proxy model 506 is then determined based on the labels 510 assigned by the proxy model 506, and labels assigned to those same data points via the second set of segmented data points 512. In some embodiments, the accuracy is measured based on a percentage of classifications or labeling performed by the proxy model 506 that match labels defined by the second segmented data points. In other embodiments, the accuracy is measured based on an absolute number of different results achieved by the proxy model 506 versus the second set of segmented data points 512. If the accuracy 514 meets one or more predefined criterion (e.g., lower than a predefined threshold), the proxy model is retrained as proxy model 516. The proxy model 516 is trained based on the second set of segmented data points 512.

FIG. 5 also illustrates comparisons made between the first set of segmented data points 504 and the second set of segmented data points 512. A first comparison, represented by a decision operation 526, determines whether any segments identified by the second set of segmented data points 512 include data points that were included in at least two different segments of the first set of segmented data points 504. If any segments identified in the second set of segmented data points 512 include data from at least two prior segments of the first set of segmented data points 504, the segmentation parameters are modified and represented as modified parameters 530 in FIG. 5. In some embodiments, the modified segmentation parameters include one or more of a hyper-parameter, a normalization range, a distance metric that quantifies similarity and thus defines neighbors. A second comparison, represented by a decision operation 528, determines if any of the segments identified within the first set of segmented data points 504 has zero associated data points in the second set of segmented data points 512. If any of the segments do have zero points associated with them in the second set of segmented data points 512, segmentation parameters are modified as represented by modified parameters 530.

FIG. 5 illustrates that the modified parameters 530 are provided to a segmentation process 535, which generates a third set of segmented data points 536. The third set of segmented data points 536 is based on at least the first set of data points 502, the second set of data points 508, and a third set of data points 538.

FIG. 5 also illustrates computation of a maximum distance between a data point labeled by the proxy model 506 (e.g., included in the second set of data points 508), and other points having an equivalent label (e.g., from the second set of data points). This maximum distance is shown in FIG. 5 as distance 520. FIG. 5 also illustrates that a maximum intra-cluster distance (MICD) 519 is determined based on the second set of segmented data points. The MICD represents a maximum distance any two data points of the second segmentation within the same cluster or segment. In other words, the second segmentation defines an association between each data point of the segmentation and a cluster or segment defined by the segmentation. A different maximum intra-cluster distance is determined, in some embodiments, based on each distinct segmentation (e.g., first set of segmented data points 504, second set of segmented data points 512, and/or third set of segmented data points 536, but not all of these maximum intra-cluster distances are shown in FIG. 5 to preserve figure clarity). A representative MICD of the second set of segmented data points is shown as MICD 519 in FIG. 5

A decision operation 524 evaluates whether the distance 520 of a particular segment or cluster is greater than the MICD 519 of the same particular segment or cluster. If the distance 520 is greater than the MICD 519, some embodiments determine that the data point upon which the distance 520 is based cannot be effectively labeled by the proxy model 506. In some embodiments, detection of such a condition initiates a re-segmentation that incorporates the data point. In some other embodiments, the unlabeled data point is stored. When a number of unlabeled data points reaches a predefined threshold, or a data point indicated as a high priority data point is unlabeled, a re-segmentation is initiated that includes the unlabeled data point(s). When the maximum distance determined based on results of the proxy model 506 exceeds the MICD, segmentation parameters are modified in some embodiments (e.g., modified parameters 530). In some embodiments, the predefined threshold is set to a previous maximum distance between the centroid and data points assigned to the cluster or segment.

Thus, FIG. 5 represents a process that is iterative in nature, at least in some embodiments. Data points are generally received on an ongoing basis. Periodically, data points accumulated up to that point are re-segmented (these segmented data points are represented by the first set of segmented data points 504, second set of segmented data points 512, and third set of segmented data points 536). Thus, there is a delay between re-segmentation. During the delay, labeling of data points is provided by a proxy model (e.g., the proxy model 506 and potentially the proxy model 516). Some re-segmentations reuse existing segmentation parameters (e.g., segmentation parameters 505). Under certain conditions, such as those identified in decision operations 526 and/or 528, segmentation parameters are modified to tune the segmentation. Subsequent segmentations (e.g. segmentation process 535 resulting in the third set of segmented data points 536) are then based on the modified segmentation parameters.

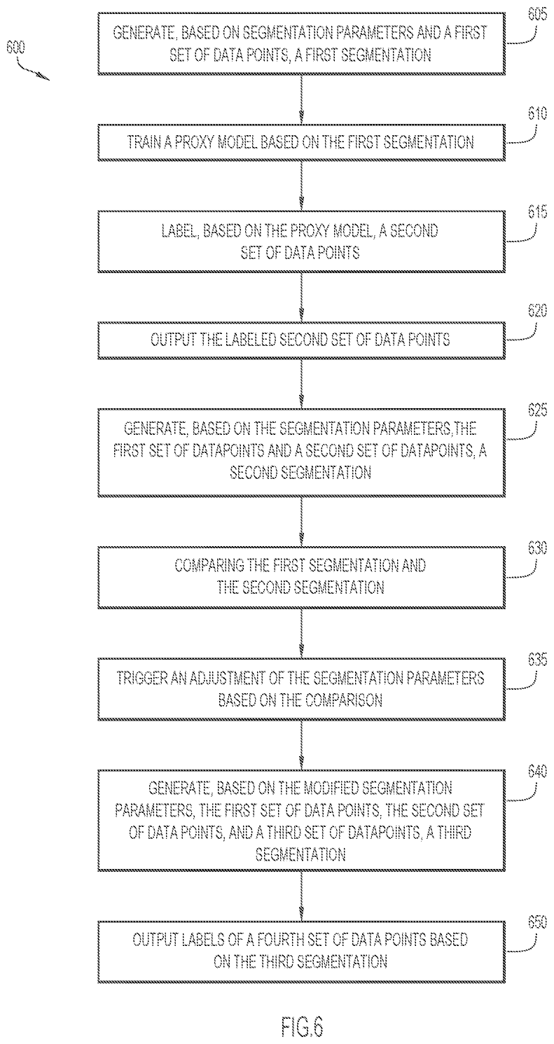

FIG. 6 is a flowchart of a method of determining when to re-label a set of data points using, e.g., the expertise of an SME. In some embodiments, method 600 is performed by the segmentation system 454, discussed above with respect to FIG. 4B.

In operation 605, a first segmentation is generated. The first segmentation is based on a first set of data points, and on one or more segmentation parameters. The one or more segmentation parameters include, in some embodiments, one or more of a normalization range, a distance function to use, a density threshold, or a number of expected clusters, label definitions of particular segments or clusters (provided by an SME in some embodiments), selection of features used for segmentation, group semantics, a hyper parameter, or other parameters).

To illustrate one example of operation 605, as discussed above with respect to FIG. 5, the first set of segmented data points 504 is generated, by the segmentation process 503, and based on the first set of data points 502. The first segmentation defines a plurality of associations between each of the first set of data points, and a cluster, segment or label (e.g. analogous to the segment or cluster 204A of FIG. 2A and/or 204B of FIG. 2B) defined by the first segmentation. Thus, the first segmentation includes one or more segments or clusters, with at least one data point of the first set of data points associated with or assigned to one of the one or more segments or clusters.

In some embodiments, the first segmentation is performed by projecting each data point of the first dataset into a vector space, and determining distances between the data points within the vector space. Data points proximate to each other within the vector space are assigned to a common segment or cluster. In some embodiments, operation 605 uses a clustering method, such as KNN to segment the first data set.

In operation 610, a proxy model is trained based on the first segmentation. For example, in some embodiments, as discussed above with respect to FIG. 5, the proxy model 506 is trained based on data points in the first set of data points 502, and labels, clusters, or segments associated with each of those first set of data points 502 in the first set of segmented data points 504.

In operation 615, a second set of data points is labeled based on the proxy model. Thus, based on the training performed in operation 610, the proxy model assigns a label to each data point in the second set of data points (e.g. the second set of data points 508). The resulting labels are analogous to the labels 510 illustrated in FIG. 5.

In operation 620, the labeled second set of data points are output. For example, as discussed above with respect to FIG. 5, in some embodiments, an application 540 consumes the labels assigned to the data points. For example, the application 540 implements, in some embodiments, a network hardware support application that generates an alert when a hardware fault is detected. In such an example embodiment, the data points represent operational parameter values of network hardware. The operational parameter values are characterized by the segmentation process as either indicative of normal operation or indicative of a fault. While this is an example of how the disclosed embodiments may be used to solve real world problems, it is just an example and the embodiments are not limited to this particular example.

In operation 625, a second segmentation is generated. The second segmentation considers both the first set of data points and the second set of data points. The second segmentation also operates based on an equivalent set of segmentation parameters as did the first segmentation of operation 605. Thus, the second segmentation associates each data point in the first set of data points and the second set of data points with one of a plurality of segments, clusters, or labels defined by the second segmentation. Note that a first set of segments, clusters, or labels defined by the first segmentation, in some circumstances, are different in at least one respect from a second set of segments, clusters, or labels defined by the second segmentation.

Operation 630 compares the first segmentation and the second segmentation. In some embodiments, operation 630 determines whether any segments defined by the first segmentation have no data points assigned to them in the second segmentation. To make this determination, operation 630 associates segments defined by the first segmentation with segments defined by the second segmentation. This association is based, in some embodiments, on a proximity of a first centroid of a first segment of the first segmentation with a second centroid of a second segment of the second segmentation. If the first centroid and second centroid are within a predefined threshold distance, within a vector space, of each other, some embodiments of operation 630 determine that the first segment and the second segment are essentially the “same” segment, despite being defined by two different segmentations. Generally, if a clustering algorithm assigns no data points to a segment or cluster, that cluster is not “defined” by the segmentation. Thus, in some embodiments, if operation 630 is unable to identify a segment in the second segmentation that is analogous or “equivalent” to any segment in the first segmentation, that segment of the first segmentation is considered to be an “empty” segment, or a segment lacking any associated data points. Identification of such an empty segment, in some embodiments, triggers a modification of segmentation parameters, as discussed below with respect to operation 635.

Some embodiments of operation 630 evaluate data points assigned to each segment or cluster of the second segmentation (e.g. as a group). If those data points (in the group) were assigned or associated with at least two different segments of the first segmentation (as a group), some embodiments trigger a modification of segmentation parameters as a result.

Some embodiments of operation 630 compare a maximum intra-cluster distance of the first segmentation to a maximum intra-cluster distance of the second segmentation. If the maximum intra-cluster distance is increasing beyond a predefined margin, some embodiments trigger a modification of segmentation parameters. In other words, if segments are being more diffuse or distributed, the segmentation parameters may need adjustment (in some embodiments, via a SME), to ensure accuracy of the segmentation remains within parameters.

Some embodiments, compare a maximum intra-cluster distance of one or more clusters of the second segmentation to a maximum distance of within those clusters when a data point labeled by the proxy model is considered. If the maximum distance determined based on the proxy model labeled data point(s) is greater than the maximum intra-cluster distance of the segment segmentation (for example), some embodiments consider this a trigger to modify segmentation parameters.

In operation 635, an adjustment of segmentation parameters is triggered based on the comparison(s) of operation 630. The adjustment modifies, any one or more of one or more of a normalization range, a distance function to use, a density threshold, or a number of expected clusters, label definitions of particular segments or clusters (provided by an SME in some embodiments), selection of features used for segmentation, group semantics, a hyper parameter, or other parameters). In some embodiments, operation 635 includes presenting a user interface, and displaying, within the user interface, one or more shapley values (e.g., average marginal contribution of a feature value across all possible clusters or segments) that demonstrate a relationship between wide dimension data and segmented narrow dimension data (such as that segmented by the second segmentation of operation 625). The user interface provides for input to be received that modifies one or more of the segmentation parameters.

In operation 640, a third segmentation is generated. Similar to the first segmentation and the second segmentation, the third segmentation defines associations between a plurality of data points and clusters, segments, or labels also defined by the third segmentation. The plurality of data points upon which the third segmentation is based includes the first set of data points, second set of data points, and a third set of data points. The third segmentation is based on the modified segmentation parameters of operation 635.

In operation 650, labels of a fourth set of data points are output (e.g., to an application analogous to the application 540). In some embodiments, operation 650 includes training a second proxy model based on the third segmentation, and classifying or otherwise labeling the fourth set of data points based on the trained second proxy model. After labeling by the second proxy model, the labeled fourth set of data points are output. In some embodiments, the output takes the form of pairs of data, with one element in the pair being a data point, and a second element in the pair being a label assigned to the data point.

In some embodiments, the training of the second proxy model is based on a determination of accuracy of the first proxy model, discussed above with respect to operation 610 and 615. For example, some embodiments compare classifications or labeling of, for example, the second set of data points by the first proxy model (e.g., analogous to labels 510 of FIG. 5) to labeling of those same data points in the second segmentation (e.g., analogous to labels defined by the second set of segmented data points 512). If accuracy of the first proxy model determined based on this comparison indicates an accuracy below a threshold or otherwise meeting one or more criterion, then the second proxy model is trained, to, at least in theory, improve the accuracy of the proxy model. Note that descriptions above of a first proxy model and a second proxy model may represent two different versions of a single proxy model, with the second proxy model including training based on additional data point and labels assigned to those data points by a segmentation, relative to the first proxy model.

In some embodiments, method 600 operates iteratively. In some embodiments, re-segmentations using common segmentation parameters are performed periodically, with results of the periodic segmentations compared to determine whether modification(s) of segmentation parameters are needed. The proxy model is also retrained periodically, in some embodiments, or when its accuracy meets one or more criterion as described above. The frequency of retraining of the proxy model may or may not match a frequency of re-segmenting, and/or modification of segmentation parameters.

The data points discussed above, including the first set of data points, second set of data points, third set of data points, and/or the fourth set of data points, represent a variety of data items, depending on embodiment. In one embodiment, the first set of data points 502 represent measurements of operational parameter values of a computer network. For example, the first set of data points 502 represent, in some of these embodiments, latency measurements, throughput measurements, dropped packets measurements, retransmissions measurements, CPU utilization measurements, memory utilization measurements, error counts, or other operational parameter values relating to operation of a computer network. In some embodiments, each data point also identifies a particular device to which the measurement pertains, or a measurement device of the data point. Some embodiments consume this type of data (e.g., operational parameters of a computer network), along with labels assigned to it, to a network diagnostic application, which is configured to predict faults in a computer network based on the labeled data. For example, a fault with one or more component devices of a computer network is identified, in some embodiments, based on the labeled data points.

In some embodiments, the data points discussed above represent more complex structures, such as electronic document data, images, media, or other structured data. Some embodiments consume labeled data of this type in order to implement a data filtering application, such as a document filter, internet filter, firewall, or data protection application. These are just two example applications of the data segmentation methods discussed above, and the disclosed embodiments are not limited to these examples.

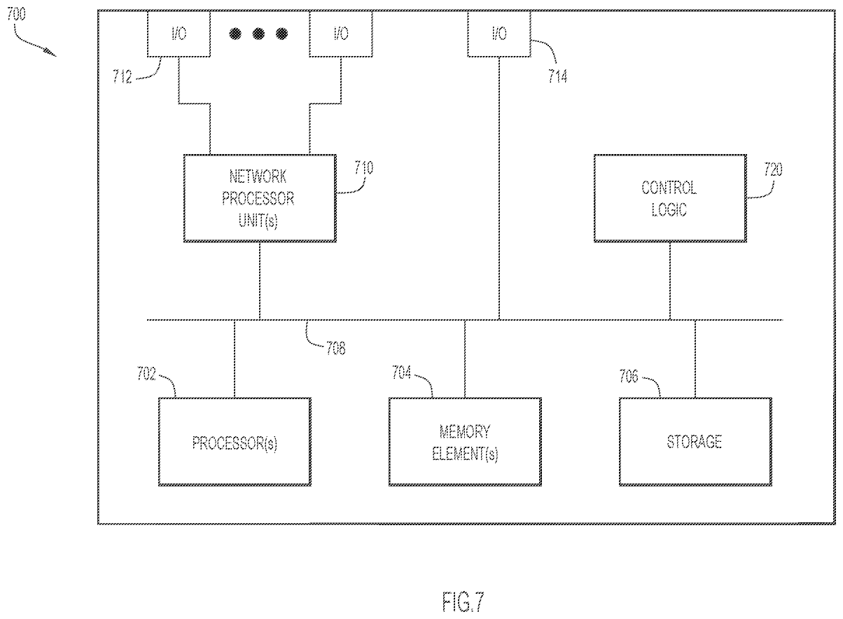

FIG. 7 is a hardware block diagram of a device 700 that may perform functions associated with operations discussed herein in connection with the techniques depicted in any one or more of FIGS. 1-6. In various embodiments, any of the components described above (e.g., the segmentation system 454) include, in some embodiments, a computing architecture analogous to that described below with respect to the device 700.

In at least one embodiment, the device 700 may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for device 700 can overlap in any manner and are not limited to the specific allocation of instructions and/or operations described herein.

In at least one embodiment, processor(s) 702 is/are at least one hardware processor configured to execute various tasks, operations and/or functions for device 700 as described herein according to software and/or instructions configured for device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, physical layer (PHY), controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with device 700, and/or logic configured for memory element(s) 704 and/or storage 706. For example, any logic described herein (e.g., control logic 720) can, in various embodiments, be stored for device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of device 700 to communicate in order to exchange information and/or data. Bus 708 can be implemented with any architecture designed for passing control, data and/or information between processors, memory elements/storage, peripheral devices, and/or any other hardware and/or software components that may be configured for device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between device 700 and other systems, devices, or entities, via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between device 700 and other systems, devices, or entities to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to device 700. For example, I/O interface(s) 714 may provide a connection to external devices such as a keyboard, keypad, a touch screen, and/or any other suitable input and/or output device now known or hereafter developed. This may be the case, in particular, when the device 700 serves as a user device described herein. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, such as display, particularly when the device 700 serves as a user device as described herein.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

[ow] In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, compact disc (CD) read only memory (ROM) (CD-ROM), digital video disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### VARIATIONS AND IMPLEMENTATIONS

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., fourth generation (4G)/fifth generation (5G)/next generation (nG), Institute of Electrical and Electronics Engineers (IEEE) 802.11, Wi-Fi®/Wi-Fi6®, IEEE 802.15 (e.g. Wireless Personal Area Networks (WPAN)), IEEE 802.16 (e.g., Worldwide Interoperability for Microwave Access (WiMAX)), Radio-Frequency Identification (RFID), Near Field Communication (NFC), Bluetooth™, millimeter (mm).wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. IP addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In one form, a method is provided that comprises generating, based on segmentation parameters and a first set of data points, a first segmentation, wherein the first segmentation associates a segment with each data point in the first set of data points, training a proxy model based on the first segmentation, labeling, based on the proxy model, a second set of data points, outputting the labeled second set of data points, generating, based on the segmentation parameters, the first set of data points and the second set of data points, a second segmentation, wherein the second segmentation associates a segment with each data point in the first set of data points and the second set of data points, comparing the first segmentation and the second segmentation, triggering an adjustment of the segmentation parameters based on the comparing, generating, based on the adjusted segmentation parameters, the first set of data points, a second set of data points, and a third set of data points, a third segmentation; and outputting a labeled fourth set of data points based on the third segmentation.

In another form, an apparatus is provided that comprises a network interface configured to enable network communications, one or more processors, and one or more memories storing instructions that when executed configure the one or more processors to perform operations comprising generating, based on segmentation parameters and a first set of data points, a first segmentation, wherein the first segmentation associates a segment with each data point in the first set of data points, training a proxy model based on the first segmentation, labeling, based on the proxy model, a second set of data points, outputting the labeled second set of data points, generating, based on the segmentation parameters, the first set of data points and the second set of data points, a second segmentation, wherein the second segmentation associates a segment with each data point in the first set of data points and the second set of data points, comparing the first segmentation and the second segmentation, triggering an adjustment of the segmentation parameters based on the comparing, generating, based on the adjusted segmentation parameters, the first set of data points, a second set of data points, and a third set of data points, a third segmentation; and outputting a labeled fourth set of data points based on the third segmentation.

The methods presented herein may be embodied in a non-transitory computer readable storage medium comprising instructions that when executed configure one or more processors to perform the operations of the method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method, comprising:
generating, based on first segmentation parameters and a first set of data points, a first segmentation, wherein the first segmentation associates a segment with each data point in the first set of data points;
training a proxy model based on the first segmentation;
labeling, based on the proxy model, a second set of data points to generate a labeled second set of data points;
outputting the labeled second set of data points;
generating, based on the first segmentation parameters, the first set of data points and the second set of data points, a second segmentation, wherein the second segmentation associates a segment with each data point in the first set of data points and the second set of data points;
comparing the first segmentation and the second segmentation;
triggering, based on the comparing, an adjustment of the first segmentation parameters to generate second segmentation parameters;
generating, based on the adjustment, second segmentation parameters;
generating, based on the second segmentation parameters, the first set of data points, a second set of data points, and a third set of data points, a third segmentation; and
outputting a labeled fourth set of data points based on the third segmentation.

2. The method of claim 1, wherein comparing the first segmentation and the second segmentation comprises determining whether each segment of the first segmentation has associated data points in the second segmentation; and modifying the first segmentation parameters in response to at least one segment of the first segmentation lacking associated data points in the second segmentation.

3. The method of claim 1, wherein comparing the first segmentation and the second segmentation comprises determining whether any segment of the second segmentation is associated with data points associated with two or more segments of the first segmentation, and modifying the first segmentation parameters in response to a segment of the second segmentation being associated with data points associated with two or more segments of the first segmentation.

4. The method of claim 1, further comprising comparing the labeled second set of data points to the second segmentation, and training the proxy model on the second segmentation in response to the comparing.

5. The method of claim 1, further comprising determining a maximum distance between each data point of the first set of data points and the second set of data points, and a centroid of a segment associated with a respective data point, and modifying the first segmentation parameters based on the determining.

6. The method of claim 1, wherein modifying the first segmentation parameters includes modifying one or more of a distance function, density threshold, a number of expected clusters, a hyper-parameter, or a label definition of particular segments or clusters.

7. The method of claim 1, wherein the first segmentation comprises reducing dimensions of the first set of data points to generate a reduced dimension set of data points, and segmenting, based on the reduced dimension set of data points.

8. The method of claim 1, further comprising presenting, on a user interface, a shapley value based on the second segmentation, and receiving input indicating a modified segmentation parameter from the user interface, wherein the third segmentation is based on the modified segmentation parameter.

9. The method of claim 8, wherein the presenting is in response to the triggering.

10. The method of claim 1, wherein the first set of data points represent operational parameter values of a computer network, and the outputting comprises outputting labeled data to a network diagnostic application, or the first set of data points represent electronic document data, and the outputting comprises outputting labeled data to a data filtering application.

11. An apparatus comprising:
a network interface configured to enable network communications; and
one or more processors, and one or more memories storing instructions that when executed configure the one or more processors to perform operations comprising:
generating, based on first segmentation parameters and a first set of data points, a first segmentation, wherein the first segmentation associates a segment with each data point in the first set of data points;
training a proxy model based on the first segmentation;
labeling, based on the proxy model, a second set of data points to generate a labeled second set of data points;
outputting the labeled second set of data points;
generating, based on the first segmentation parameters, the first set of data points and the second set of data points, a second segmentation, wherein the second segmentation associates a segment with each data point in the first set of data points and the second set of data points;
comparing the first segmentation and the second segmentation;
triggering, based on the comparing, an adjustment of the first segmentation parameters to generate second segmentation parameters;
generating, based on the adjustment, second segmentation parameters;
generating, based on the second segmentation parameters, the first set of data points, a second set of data points, and a third set of data points, a third segmentation; and
outputting a labeled fourth set of data points based on the third segmentation.

12. The apparatus of claim 11, wherein comparing the first segmentation and the second segmentation comprises determining whether each segment of the first segmentation has associated data points in the second segmentation; and modifying the first segmentation parameters in response to at least one segment of the first segmentation lacking associated data points in the second segmentation.

13. The apparatus of claim 11, wherein comparing the first segmentation and the second segmentation comprises determining whether any segment of the second segmentation is associated with data points associated with two or more segments of the first segmentation, and modifying the first segmentation parameters in response to a segment of the second segmentation being associated with data points associated with two or more segments of the first segmentation.

14. The apparatus of claim 11, the operations further comprising comparing the labeled second set of data points to the second segmentation, and training the proxy model on the second segmentation in response to the comparing.

15. The apparatus of claim 11, wherein modifying the first segmentation parameters includes modifying one or more of a distance function, density threshold, a number of expected clusters, a hyper-parameter, or a label definition of particular segments or clusters.

16. A non-transitory computer readable storage medium comprising instructions that when executed configure one or more processors to perform operations comprising:
generating, based on first segmentation parameters and a first set of data points, a first segmentation, wherein the first segmentation associates a segment with each data point in the first set of data points;
training a proxy model based on the first segmentation;
labeling, based on the proxy model, a second set of data points to generate a labeled second set of data points;
outputting the labeled second set of data points;
generating, based on the first segmentation parameters, the first set of data points and the second set of data points, a second segmentation, wherein the second segmentation associates a segment with each data point in the first set of data points and the second set of data points;
comparing the first segmentation and the second segmentation;
triggering, based on the comparing, an adjustment of the first segmentation parameters to generate second segmentation parameters;
generating, based on the adjustment, second segmentation parameters;
generating, based on the second segmentation parameters, the first set of data points, a second set of data points, and a third set of data points, a third segmentation; and
outputting a labeled fourth set of data points based on the third segmentation.

17. The non-transitory computer readable storage medium of claim 16, wherein comparing the first segmentation and the second segmentation comprises determining whether each segment of the first segmentation has associated data points in the second segmentation; and modifying the first segmentation parameters in response to at least one segment of the first segmentation lacking associated data points in the second segmentation.

18. The non-transitory computer readable storage medium of claim 16, wherein comparing the first segmentation and the second segmentation comprises determining whether any segment of the second segmentation is associated with data points associated with two or more segments of the first segmentation, and modifying the first segmentation parameters in response to a segment of the second segmentation being associated with data points associated with two or more segments of the first segmentation.

19. The non-transitory computer readable storage medium of claim 16, the operations further comprising comparing the labeled second set of data points to the second segmentation, and training the proxy model on the second segmentation in response to the comparing.

20. The non-transitory computer readable storage medium of claim 16, the operations further comprising determining a maximum distance between each data point of the first set of data points and the second set of data points, and a centroid of a segment associated with a respective data point, and modifying the first segmentation parameters based on the determining.
